(19) United States
(12) Patent Application Publication
(10) Pub. No.: US 2026/0004620 A1
(43) Pub. Date: Jan. 1, 2026

(54) INFORMATION PROCESSING DEVICE

(71) Applicant: TOYOTA JIDOSHA KABUSHIKI KAISHA, Toyota-shi (JP)

(72) Inventors: Toshio UCHIYAMA, Toyota-shi (JP); Daichi NAGATA, Nagoya-shi (JP); Kenji TAKAHASHI, Toyota-shi (JP); Yasuhide KURIMOTO, Kasugai-shi (JP); Isao SATO, Nagoya-shi (JP); Kenji ZAITSU, Nagoya-shi (JP); Takayuki KANDA, Okazaki-shi (JP)

(73) Assignee: TOYOTA JIDOSHA KABUSHIKI KAISHA, Toyota-shi (JP)

(21) Appl. No.: 19/076,824

(22) Filed: Mar. 11, 2025

(30) Foreign Application Priority Data
Jun. 27, 2024 (JP) 2024-104202

(51) Int. Cl. G07C 5/08; B60L 58/16; G06Q 10/30

(52) U.S. Cl. CPC G07C 5/0816; B60L 58/16; G06Q 10/30

(57) ABSTRACT

Provided is a control unit that is configured to execute acquiring first information that relates to a battery that is needed by a first user who performs secondary usage of the battery, and that includes information relating to at least a shape of the battery, acquiring second information regarding the battery that is in use by a plurality of second users, and that includes information relating to at least the shape of the battery, and transmitting, to a terminal of a second user corresponding to a battery from the battery that is in use by the second users and is of a shape that matches the shape of the battery that the first user needs, a notification regarding provision of the battery, in accordance with the first information and the second information.

### CROSS-REFERENCE TO RELATED APPLICATION

This application claims priority to Japanese Patent Application No. 2024-104202 filed on Jun. 27, 2024. The disclosure of the above-identified application, including the specification, drawings, and claims, is incorporated by reference herein in its entirety.

### BACKGROUND

### 1. Technical Field

The present disclosure relates to an information processing device.

### 2. Description of Related Art

WO 2015/12144 discloses that a secondary usage destination of a battery that is in use is decided in advance, before end of use thereof, based on a predicted end of use time. Japanese Unexamined Patent Application Publication No. 2021-131671 (JP 2021-131671 A), Japanese Unexamined Patent Application Publication No. 2021-136828 (JP 2021-136828 A), and Japanese Unexamined Patent Application Publication No. 2020-119369 (JP 2020-119369 A) disclose related art.

### SUMMARY

An object of the present disclosure is to quickly collect batteries to be reused.

One aspect of the present disclosure is an information processing device, including a control unit that is configured to execute
acquiring first information that relates to a battery that is needed by a first user who performs secondary usage of the battery, and that includes information relating to at least a shape of the battery,
acquiring second information regarding the battery that is in use by a plurality of second users, and that includes information relating to at least the shape of the battery, and
transmitting, to a terminal of a second user corresponding to a battery from the battery that is in use by the second users and is of a shape that matches the shape of the battery that the first user needs, a notification regarding provision of the battery, in accordance with the first information and the second information.

Also, another aspect of the present disclosure is an information processing method for causing a computer to execute the above information processing, a program for causing a computer to execute the information processing method, and a computer-readable storage medium storing the program in a non-transitory manner.

According to the present disclosure, batteries to be reused can be quickly collected.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram schematically illustrating an example of configurations of a vehicle, a first user terminal, a server, and a second user terminal constituting a system according to an embodiment;

FIG. 2 is a sequence diagram illustrating an overall process of the system when a request for providing a battery is made to a second user according to the embodiment;

FIG. 3 is a flowchart illustrating a process of requesting a second user to provide a battery in the server according to the first embodiment;

FIG. 4 is a flow chart illustrating a process of requesting a second user to provide batteries in the servers according to the second embodiment; and

FIG. 5 is a flowchart illustrating processing when a request for providing a battery is made to a second user in the server according to the third embodiment.

### DETAILED DESCRIPTION OF EMBODIMENTS

When a battery is reused (also referred to as secondary use), a necessary number of batteries may not be collected. Here, it is assumed that a battery for a vehicle (hereinafter, also referred to as an in-vehicle battery) is reused as a stationary battery (hereinafter, also referred to as a stationary battery). The stationary battery may need a plurality of in-vehicle batteries. In this case, it is necessary to collect a plurality of on-vehicle batteries from a plurality of vehicles. In addition, a vehicle-mounted battery may have a different shape depending on the vehicle. For example, when there is a limit on the size (lateral width, height, depth) of a battery that can be stored in a housing of a stationary battery, even if a vehicle-mounted battery in which any of the lateral width, height, and depth exceeds the size of a battery that can be stored in the housing of the stationary battery is collected, the battery cannot be reused for the stationary battery. Further, the in-vehicle battery can maintain the quality only for about three months, for example, after being removed from the vehicle. Therefore, if the needed number of batteries is not collected within three months after the user acquires the first in-vehicle battery, the user cannot use the first in-vehicle battery acquired by the user. As described above, the battery collected by the user may be wasted.

In order to solve such a problem, a control unit included in an information processing device according to one aspect of the present disclosure acquires first information related to the battery needed by a first user who secondarily uses the battery, the first information including at least information related to the shape of the battery. The first user is, for example, a business operator that secondarily uses a battery. This battery is a battery that has been used elsewhere in the past, and is a battery that is used for secondary use. The battery may be, for example, a battery mounted on a BEV (Battery Electric Vehicle). The information on the shape of the battery may be, for example, information on the size (lateral width, height, and depth) or information on the position of a fixed point (which may be a fastening point) when the battery pack is arranged. Further, the information on the shape of the battery may be information capable of determining whether or not the battery can be stored in the housing of the stationary battery. As another example, the product number of the housing of the stationary battery to be used by the first user may be acquired as information regarding the shape of the battery. In this case, the relationship between the product number of the housing of the stationary battery and the size of the battery that can be stored in the stationary battery or the position of the fixing point (which may be a fastening point) at the time of disposing the battery pack may be stored in the storage unit of the information processing device. When the control unit acquires the first information, the shape of the battery to be collected can be grasped. Further, the first information may include information about a time limit for collecting the battery, first position information about a position where the battery is used, or first material information about a material of the battery needed by the first user. In addition, the first information may include information on a degree of deterioration of the battery allowed by the first user. The first information may be transmitted from a terminal of the first user.

In addition, the control unit acquires second information regarding the battery in use by the plurality of second users, the second information including at least information regarding the shape of the battery. Here, the shape of the battery may be a shape of a cell, a stack, or a pack. The information on the shape of the battery may be, for example, information on the size (lateral width, height, and depth) or information on the position of a fixing point (which may be a fastening point) when the battery pack is attached to the vehicle. As another example, the vehicle body number or the vehicle type of the vehicle used by the second user may be acquired as information about the shape of the battery. In this case, the relationship between the vehicle body number or the vehicle type of the vehicle and the vehicle body number or the size of the battery corresponding to the vehicle type or the position of the fixing point (which may be a fastening point) when the battery pack is attached to the vehicle may be stored in the storage unit of the information processing device. Note that the second information may include second position information regarding a position where the battery is used, second material information regarding a material of the battery, or information regarding a degree of deterioration of the battery. The battery in use by the second user is a battery that the first user may use for secondary use. The second information may be obtained from a terminal of the second user, or the battery may be obtained from, for example, a vehicle in use.

In accordance with the first information and the second information, the control unit transmits a notification regarding the provision of the battery to a terminal of a second user corresponding to a battery having a shape matching the shape of the battery needed by the first user among the batteries in use by the plurality of second users. The notification regarding the provision of the battery may include a notification indicating that the battery is to be purchased, or may include information regarding the consideration (for example, the purchase amount of the battery). The “battery having a shape matching the shape of the battery needed by the first user” may be a battery that can be stored in the housing of the battery used by the first user, among the batteries used by the second user. As another example, the “battery having a shape matching the shape of the battery needed by the first user” may be a battery in which a position of a fixing point (which may be a fastening point) at the time of attaching the battery pack to the vehicle matches a position of a fixing point (which may be a fastening point) of the battery pack provided in the housing of the battery used by the first user. By transmitting the notification to the terminal of the second user, the battery of the shape needed by the first user can be quickly collected.

In a case where a battery needed by the first user is not available within a predetermined period, the control unit may transmit a notification regarding the provision of the battery to a terminal of a second user corresponding to a battery having a shape smaller than a shape of a battery needed by the first user among the batteries used by the plurality of second users, in accordance with the first information and the second information. Here, the predetermined period may be a period in which it is considered that the battery cannot be obtained from the second user even after waiting any longer. As another example, a predetermined period may be set in accordance with the time limit for the first user to collect the battery. Here, when a plurality of batteries are stored in a housing and reused as a single battery, a battery having a size that can be stored in the housing can be used. That is, even when the size of the battery being used by the second user is smaller than the size needed by the first user, it is possible to dispose the battery in the housing of the battery used by the first user. In a case where the batteries of the shape needed by the first user are not collected, the battery collected so far can be suppressed from being wasted by substituting the batteries of the smaller shape. As described above, the control unit relaxes the condition regarding the shape according to the timing. On the other hand, if a small-size battery is used, the capacity may be reduced, and therefore, if a small-size battery is not collected in a period other than a predetermined period, the capacity may be suppressed from being excessively reduced. Note that the control unit may reduce the size of the battery to be collected stepwise.

In addition, the control unit may include, in the notification, information on a price for providing the battery. Since the second user who intends to provide the battery is expected to increase by presenting the consideration for the provision of the battery to the second user, the battery can be easily collected.

The control unit may be further configured to: acquire information on a life expectancy of a vehicle used by the second user and on which the battery is mounted; and transmit the notification to a terminal of a second user corresponding to the vehicle whose life expectancy is within a predetermined period. Here, the predetermined period is a period in which the possibility of replacing the vehicle due to the life expectancy of the vehicle is high. The information on the life expectancy of the vehicle may be, for example, information on the service life expectancy of the vehicle itself or information on the service life expectancy of the battery. The information on the life expectancy of the vehicle may be stored in the storage unit of the information processing device in association with each vehicle. Even after the service life expectancy of the vehicle, the battery can be reused. A second user of a vehicle having an approaching life expectancy may be considering replacing the vehicle. The second user who has received the notification at this time has a high possibility of replacing the vehicle at this timing. Therefore, it is easy to collect batteries having a needed shape.

Hereinafter, embodiments of the present disclosure will be described with reference to the drawings. The configuration of the following embodiment is an example, and the present disclosure is not limited to the configuration of the embodiment. Further, the following embodiments can be combined as much as possible.

### First Embodiment

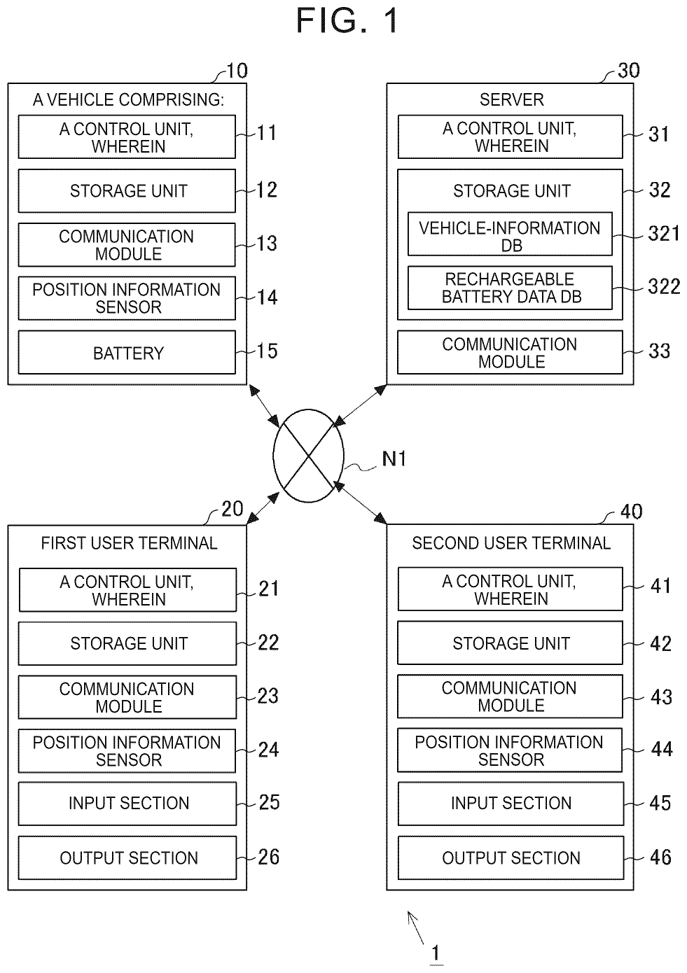

FIG. 1 is a block diagram schematically illustrating an example of configurations of a vehicle 10, a first user terminal 20, a server 30, and a second user terminal 40 constituting the system 1 according to the present embodiment. In the example illustrated in FIG. 1, the system 1 includes a vehicle 10 on which a battery 15 is mounted, a first user terminal 20 used by a first user who collects a battery to be secondary used, a server 30, and a second user terminal 40 which is a terminal used by a second user who is a user of the vehicle 10. There may be a plurality of vehicles 10, first user terminals 20, and second user terminals 40. The vehicles 10, the first user terminals 20, the servers 30, and the second user terminals 40 are connected to each other via a networked N1. Note that the network N1 may be, for example, a global public communication network such as the Internet (WAN (Wide Area Network) or another communication network. The network N1 may include a telephone communication network such as a mobile telephone, and a radio communication network such as Wi-Fi.

The vehicle 10 is, for example, a vehicle on which batteries 15 such as BEV are mounted. The battery 15 supplies electric power to an electric motor that drives the vehicle 10. The battery 15 is a battery that can be used as a secondary battery. The vehicle 10 includes a control unit 11, a storage unit 12, a communication module 13, a position information sensor 14, and a battery 15. The control unit 11 is an arithmetic unit that realizes various functions of the vehicle 10 by executing a predetermined program. The control unit 11 can be realized by, for example, a hardware processor such as a CPU. The storage unit 12 is a unit that stores information, and is configured by a storage medium such as a RAM, a magnetic disk, or a flash memory. The storage unit 12 stores a program executed by the control unit 11, data used by the program, and the like.

The communication module 13 is a communication unit for connecting the vehicles 10 to the networked N1. In the present embodiment, vehicles 10 can communicate with other devices (for example, servers 30) over a networked N1 using a mobile communication service such as 3G, LTE, 5G, 6G. The position information sensor 14 acquires position information (for example, latitude and longitude) at a predetermined cycle. The position information sensor 14 is, for example, a GPS (Global Positioning System) receiver, a radio communication unit, or the like.

The control unit 11 of the vehicle 10 transmits vehicle information including information on the state of the battery 15 to the server 30 at a predetermined timing. The predetermined timing may be when the vehicle 10 is activated or parked, or may be every predetermined time. The control unit 11 may calculate, for example, SOH (State of Health) and transmit SOH to the servers 30. Note that the control unit 11 may acquire SOH by using known methods. Further, the status of the batteries 15 transmitted by the control unit 11 to the servers 30 is not limited to SOH. For example, the control unit 11 may transmit SOC (State Of Charge), a lithium-deposition rate, or the like to the servers 30. The control unit 11 transmits the vehicle information to the server 30. The vehicle information includes, for example, a vehicle ID, a user ID, a battery ID, second position information regarding a position in which the battery 15 is used, second material information regarding a material of the battery 15, date and time information, and information (for example, SOH information) regarding a degradation degree of the battery 15. The battery 15 can be secondarily used in units of, for example, a cell, a stack, or a pack. The control unit 11 of the vehicle 10 may detect a state of deterioration for each unit such as a cell, a stack, or a pack, and transmit the detected state to the server 30. Further, the vehicle information may include information about the shape of the battery 15. The shape of the battery 15 may be a unit shape such as a cell, a stack, or a pack. As another example, the relation between the battery ID or the vehicle ID and the information about the shape of the battery 15 may be stored in the storage unit 32 of the server 30, which will be described later.

The first user terminal 20 is a terminal used by the first user, and is, for example, a smart phone, a tablet terminal, a wearable terminal, or a PC (Personal Computer). The first user is, for example, a business operator that reuses the battery 15. An application software or a web browser for collecting batteries, for example, is installed in the first user terminal 20. The first user terminal 20 includes a control unit 21, a storage unit 22, a communication module 23, a position information sensor 24, an input unit 25, and an output unit 26. The control unit 21 of the first user terminal 20 can be realized by, for example, a hardware processor such as a CPU. The storage unit 22 is a unit that stores information, and is configured by a storage medium such as a RAM, a magnetic disk, or a flash memory. The storage unit 22 stores a program executed by the control unit 21, data used by the program, and the like. The communication module 23 and the position information sensor 24 of the first user terminal 20 have the same configuration as the communication module 13 and the position information sensor 14 of the vehicle 10.

The input unit 25 is a unit that receives an input operation or the like performed by a user, and includes, for example, a touch panel, a mouse, a keyboard, a microphone, or the like. The output unit 26 is a unit for presenting information to a user, and may include, for example, LCD (Liquid Crystal Display), EL (Electroluminescence), a speaker, a lamp, and the like. The input unit 25 and the output unit 26 may be configured as a single touch panel display.

The control unit 21 of the first user terminal 20 receives input of information (hereinafter, also referred to as secondary battery information) related to the battery 15 collected for secondary use (reuse). The first user inputs the secondary battery information via the input unit 25. The secondary battery information includes a user ID, information related to a specification of the battery 15 needed by the first user, first position information related to a position where the battery 15 is used, first material information related to a material of the battery 15 needed by the first user, information related to an allowable degree of deterioration of the battery 15, information related to an allowable amount of consideration, information related to a time limit for collecting the battery 15, and information related to a needed shape of the battery (hereinafter, also referred to as first shape information). The first user may perform user registration in advance with respect to the server 30 via the input unit 25 of the first user terminal 20. The first shape information may be information related to a product number of the housing associated with the shape of the battery.

The second user terminal 40 is a terminal used by the second user, and is, for example, a smart phone, a tablet terminal, a wearable terminal, or a PC (PersonalComputer. The second user terminal 40 may be a terminal mounted on the vehicle 10. An application software or a web browser that receives a notification from the server 30, for example, is installed in the second user terminal 40. The second user terminal 40 includes a control unit 41, a storage unit 42, a communication module 43, a position information sensor 44, an input unit 45, and an output unit 46. The control unit 41 of the second user terminal 40 can be realized by, for example, a hardware processor such as a CPU. The storage unit 42 is a unit that stores information, and is configured by a storage medium such as a RAM, a magnetic disk, or a flash memory. The storage unit 42 stores a program executed by the control unit 41, data used by the program, and the like. The communication module 43, the position information sensor 44, the input unit 45, and the output unit 46 of the second user terminal 40 have the same configuration as the communication module 23, the position information sensor 24, the input unit 25, and the output unit 26 of the first user terminal 20.

The control unit 41 of the second user terminal 40, upon receiving a notification regarding a request for provision of the battery 15 from the server 30, causes the display of the output unit 46 to display an image corresponding to the notification. The second user who sees the notification inputs the answer via the input unit 45 of the second user terminal 40. The control unit 41 that has received the input of the answer transmits information related to the answer to the server 30.

The server 30 can be configured as a computer including a processor (such as a CPU, GPU), a main storage device (such as a RAM, ROM), and a secondary storage device (such as an EPROM, a hard disk drive, and a removable medium). The secondary storage device stores an operating system (OS), various programs, various tables, and the like, and the programs stored therein are executed to realize respective functions (software modules) that match predetermined objectives. The server 30 includes a control unit 31, a storage unit 32, and a communication module 33.

The control unit 31 is an arithmetic unit that realizes various functions of the server 30 by executing a predetermined program. The control unit 31 can be realized by, for example, a hardware processor such as a CPU. The control unit 31 may include a RAM, ROM, a cache memory, and the like. Details of the control unit 31 will be described later.

The storage unit 32 is a unit that stores information, and is configured by a storage medium such as a RAM, a magnetic disk, or a flash memory. The storage unit 32 stores a program executed by the control unit 31, data used by the program, and the like. In addition, a database (vehicle information DB321 and secondary battery information DB322) is constructed in the storage unit 32, and information collected from each vehicle 10 and information collected from each first user terminal 20 are stored in the database.

The vehicle information DB321 stores vehicle information received from the vehicle 10. The vehicle information includes a vehicle ID, a user ID, a battery ID, second position information, second material information, date and time information, SOH information, and second shape information. The vehicle ID is identification information unique to the vehicle 10. The user ID is unique to the second user or the second user terminal 40. The battery ID is an identity unique to the battery 15. Note that the battery ID may be provided for each unit to be reused, for example. The second position information is information related to the position of the vehicle 10 when the information is transmitted from the vehicle 10, and is, for example, information indicated by coordinates. The second material information is information about the material of the battery 15. The date and time information is information on the date and time when SOH information is transmitted from the vehicles 10. SOH information is information about SOH of the batteries 15. The second shape information is information about the shape of the battery 15 mounted on the vehicle 10. The second shape information includes, for example, information on sizes such as a width, a height, and a depth. Note that the relation between the second shape-information and the battery ID or the vehicle ID may be stored in advance in the storage unit 32. Then, the control unit 31 may identify the second shape information by comparing the vehicle ID or the battery ID received from the vehicle 10 with the information stored in the storage unit 32. The control unit 31 stores the vehicle information received from the vehicle 10 in the vehicle information DB321.

The secondary battery information DB322 stores information related to the battery 15 needed by the first user. In the secondary battery information DB322, information on the shape of the battery 15 needed by the first user (that is, the first shape information) is stored in association with the user ID. The secondary battery information DB322 includes information related to the specifications of the battery 15 needed by the first user, first position information related to the position where the battery 15 is used, first material information related to the material of the battery 15 needed by the first user, information related to the degree of degradation of the battery 15 allowed, information related to the amount of consideration allowed, information related to the time limit for collecting the battery 15, and the like. The control unit 31 stores the secondary battery information received from the first user terminal 20 in the secondary battery information DB322.

The communication module 33 is a communication interface for connecting the servers 30 to the network N1. The communication module 33 may be configured to include, for example, a network interface board, a wireless communication interface for wireless communication, and the like. The server 30 can perform data communication with the vehicle 10, the first user terminal 20, and the second user terminal 40 via the communication module 33.

Next, the control unit 31 of the server 30 will be described in detail. The control unit 31 of the server 30 acquires the secondary battery information from the first user terminal 20. Note that the control unit 31 may directly acquire information on the shape of the battery 15 from the first user terminal 20 as the first shape information. Further, the control unit 31 may acquire the first position information and the first material information from the first user terminal 20. For example, if the position where the first user secondary use of the battery 15 and the position where the second user is using the battery 15 is close, since the distance to carry the battery in the secondary use of the battery 15 is shortened, it is possible to reduce the transportation cost. Therefore, by the control unit 31 acquiring the first position information, the cost can be reduced. The battery 15 includes a plurality of types of materials. Examples of the material of the batteries 15 include LFP and ternary systems. When a plurality of batteries 15 are used, there is a desire to unify the plurality of batteries using the same material, and therefore, the control unit 31 can respond to this desire by acquiring the first material information.

The second position information is a position of the vehicle 10 acquired by the position information sensor 14 of the vehicle 10. As another example, the second position information may be information regarding either the position of the second user terminal 40 acquired by the position information sensor 44 of the second user terminal 40 or the position input by the second user to the second user terminal 40 via the input unit 45. Further, the second material information may be information that allows the material of the battery 15 used in the vehicle 10 to be determined, and may be, for example, information related to a vehicle body number or information related to a vehicle type of the vehicle 10. The control unit 31 of the server 30 may specify, for example, the material of the battery 15 mounted on the vehicle 10 from the vehicle body number or the vehicle type based on the information stored in the storage unit 32. The degree of deterioration of the battery 15 may be calculated by the control unit 11 of the vehicle 10, or may be calculated by the control unit 31 of the server 30 based on data transmitted from the vehicle 10. In addition, the second shape information may be information that can determine the shape of the battery 15 used in the vehicle 10, and may be, for example, information related to the vehicle body number of the vehicle 10 or information related to the vehicle type. The control unit 31 of the server 30 may specify, for example, the shape of the battery 15 mounted on the vehicle 10 from the vehicle body number or the vehicle type based on the information stored in the storage unit 32.

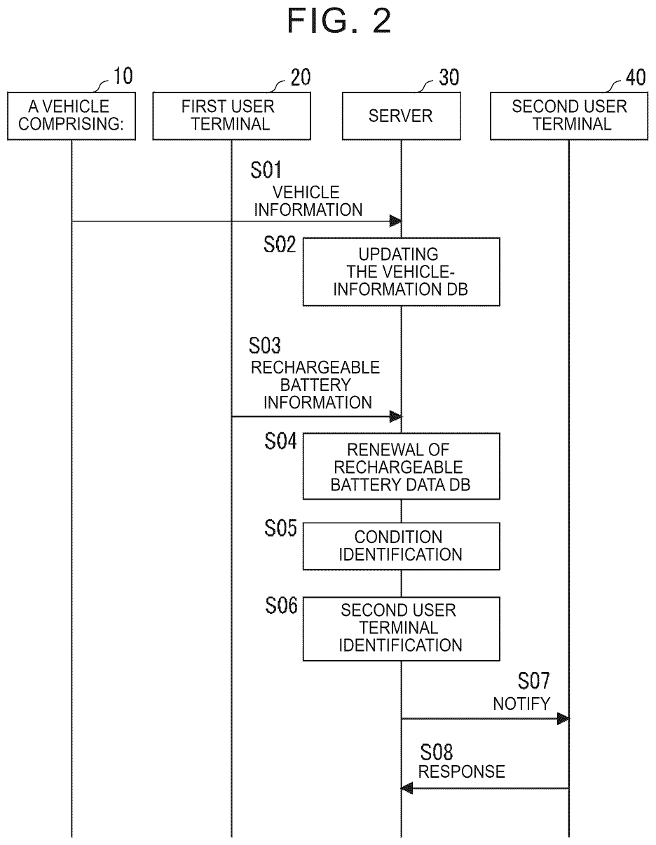

FIG. 2 is a sequence diagram illustrating an overall process of the system 1 when a request for providing the battery 15 is made to the second user according to the embodiment. The control unit 11 of the vehicle 10 transmits the vehicle data to the servers 30 at predetermined timings (S01). The control unit 31 of the server 30 that has received the vehicle information updates the vehicle information DB321 by storing the vehicle information in the vehicle information DB321 (S02). The processes in S01 and S02 are performed for the plurality of vehicles 10, respectively. In addition, upon receiving a predetermined input from the first user, the control unit 21 of the first user terminal 20 generates secondary battery information and transmits the secondary battery information to the servers 30 (S03). The control unit 31 of the server 30 updates the secondary battery information DB322 by storing the secondary battery information in the secondary battery information DB322 (S04). Further, the control unit 31 of the server 30 specifies a condition for collecting the battery 15 (hereinafter, also referred to as a battery collection condition) in accordance with the received secondary battery data (S05). This battery collection condition includes a condition regarding the shape of the battery 15 to be collected. Further, the battery collection condition includes conditions such as, for example, collecting the battery 15 from within a predetermined area, collecting the battery 15 having a deterioration degree equal to or less than a threshold value, or collecting the battery 15 of a predetermined material, and conditions related to the consideration. In addition, the control unit 31 of the server 30 identifies the second user terminal 40 corresponding to the battery-collection condition (S06). The control unit 31 transmits a notification regarding the provision of the batteries 15 to the identified second user terminal 40 (S07). Upon receiving the notification, the control unit 41 of the second user terminal 40 outputs an image corresponding to the notification to the display of the output unit 46. At this time, the control unit 41 of the second user terminal 40 outputs a user interface for inputting an answer to the notification. When the second user inputs an answer via the input unit 45, the control unit 41 of the second user terminal 40 transmits the answer to the servers 30 (S08).

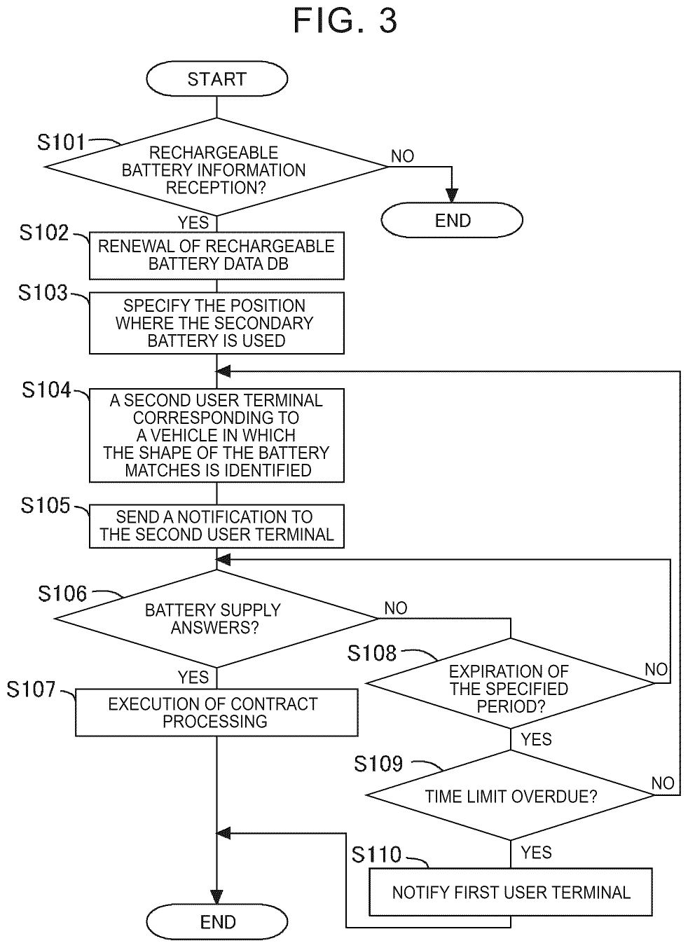

FIG. 3 is a flowchart illustrating processing when the server 30 according to the first embodiment requests the second user to provide the battery 15. The flowchart illustrated in FIG. 3 is executed in the server 30 at predetermined time intervals. It is assumed that the vehicle information DB321 stores needed information.

In S101, the control unit 31 determines whether or not the secondary battery data has been received from the first user terminal 20. The secondary battery information includes first shape information regarding the shape of the battery 15 needed by the first user, time limit information regarding the time limit for the first user to collect the battery 15, first position information regarding the position where the battery 15 is used, first material information regarding the material of the battery 15 needed by the first user, and the like. In addition, the secondary battery information may include, for example, information on the amount of consideration allowed by the first user. Further, the secondary battery information may include, for example, information on the degree of deterioration of the battery 15 allowed by the first user. If the control unit 31 makes an affirmative determination in S101, the process proceeds to S102, and if a negative determination is made, the routine ends. In S102, the control unit 31 updates the secondary battery information DB322 in accordance with the received secondary battery information.

In S103, the control unit 31 specifies a position at which the first user secondarily uses the battery 15 (hereinafter, also referred to as a secondary battery use position). This position may be a position input by the first user via the input unit 25 of the first user terminal 20 or a position indicated by the position information of the first user terminal 20. The secondary battery use position is specified in accordance with the first position information. In S104, the control unit 31 identifies a terminal of a user of the vehicle 10 on which the battery 15 having a shape matching the battery 15 having a shape needed by the first user is mounted, or the vehicle 10. At this time, the control unit 31 compares the first shape information with the second shape information. Note that the control unit 31 may be specified only in the second user terminal 40 located within a predetermined distance from the secondary battery use position. As another example, the control unit 31 may specify the vehicle 10 located within a predetermined distance from the secondary battery use position. The positions of the second user terminal 40 and the vehicle 10 are transmitted from the second user terminal 40 and the vehicle 10 at predetermined time intervals. Further, as another example, the control unit 31 may specify the second user terminal 40 or the vehicle 10 located within a predetermined distance from the secondary battery use position in accordance with the area or the address associated with the vehicle 10 registered by the second user.

Note that the farther away from the secondary battery use position, the higher the cost for transporting the battery 15, and therefore, for example, the predetermined distance may be set based on the transportation cost allowed by the first user. In addition, the control unit 31 may specify the material and type of the mounted battery 15 only in the vehicle 10 that is the same as the material and type of the battery 15 that have been collected and the second user terminal 40 that corresponds to the vehicle 10, in the present S104. As yet another example, the control unit 31 may specify the material and the type of the battery 15 to be mounted only in the vehicle 10 that is the same as the material and the type of the battery 15 desired by the first user and the second user terminal 40 that corresponds to the vehicle 10 in the present S104. Note that the control unit 31 may omit S103 and S104 processes. In this case, the control unit 31 may identify all the second user terminals 40 or all the vehicles 10.

In S105, the control unit 31 transmits a notification related to the provision of the batteries 15 to the second user terminal 40 identified in S104. The notification regarding the provision of the battery 15 includes information regarding each of the request for the provision of the battery 15 and the amount of the consideration given to the second user. In addition, the notification regarding the provision of the battery 15 includes a command for displaying each of the request for the provision of the battery 15 and the amount of the consideration given to the second user on the display of the output unit 46 of the second user terminal 40.

In S106, the control unit 31 determines whether or not an answer to the effect that the batteries 15 are to be provided is obtained from the second user terminal 40. In S106, if the control unit 31 makes an affirmative determination, the process proceeds to S107, and if it makes a negative determination, the process proceeds to S108. In S107, the control unit 31 executes a process for contracting with the second user to provide the batteries 15.

On the other hand, in S108, the control unit 31 determines whether or not a predetermined period has elapsed since the completion of S105 process. Here, the predetermined period is a period in which it is considered that an answer cannot be obtained from the second user terminal 40 even after waiting any longer. In S108, if the control unit 31 makes an affirmative determination, the process proceeds to S109, and if it makes a negative determination, the process returns to S106. In S109, the control unit 31 determines whether or not the time limit for collecting the batteries 15 has been exceeded. The time limit may be, for example, a time limit specified by the first user via the input unit 25 of the first user terminal 20, or may be a fixed time limit determined in advance. In S109, if the control unit 31 makes an affirmative determination, the process proceeds to S110, and if it makes a negative determination, the process returns to S104. In S110, the control unit 31 notifies the first user terminal 20 that the batteries 15 are not gathered. When the time limit is not exceeded, the control unit 31 may specify only the second user terminal 40 that has not yet transmitted the notification in S104.

As described above, according to the present embodiment, the control unit 31 can collect the battery 15 having the shape needed by the first user. That is, the battery 15 to be reused by the first user can be quickly collected.

### Second Embodiment

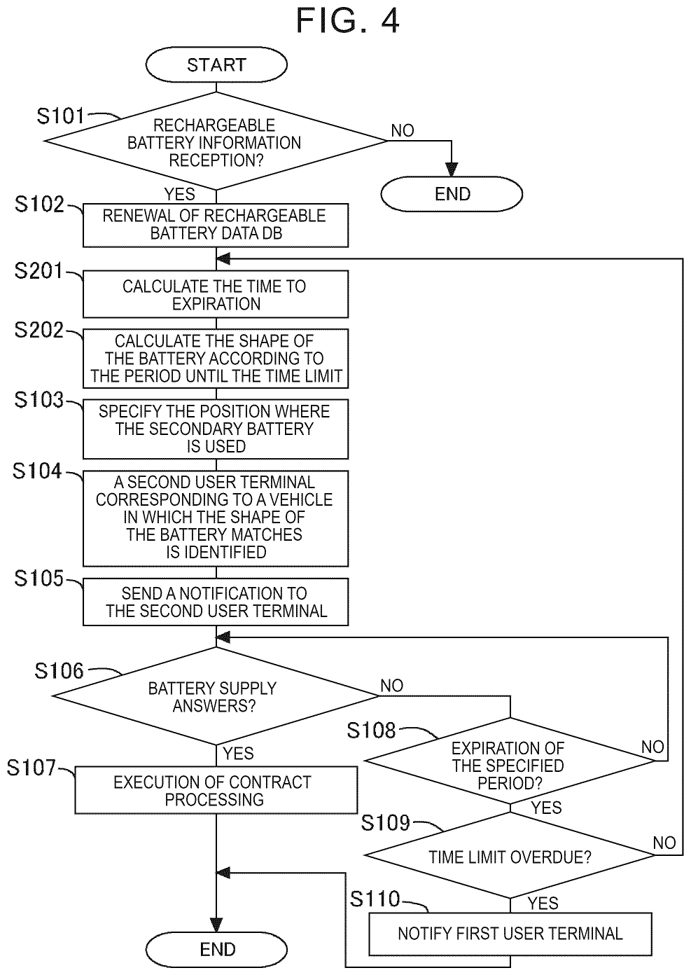

In the second embodiment, a notification is sent to the second user terminal 40 corresponding to the battery 15 having a smaller shape than the battery 15 needed by the first user in accordance with the period until the time limit for collecting the battery 15. FIG. 4 is a flowchart illustrating processing when the server 30 according to the second embodiment requests the second user to provide the battery 15. The flowchart illustrated in FIG. 4 is executed in the server 30 at predetermined time intervals. It is assumed that the vehicle information DB321 stores needed information. The description of the steps in which the same processing as the flowchart shown in FIG. 3 is executed is omitted.

In the flow chart shown in FIG. 4, when the process of S102 is completed, the process proceeds to S201. In S201, the control unit 31 calculates a period from the current time point to the time limit in accordance with the time limit data acquired in S101. Further, in S202, the control unit 31 calculates the shape of the batteries 15 according to the time until the time limit. At this time, the control unit 31 calculates the shape of the battery 15 so that the size of the battery 15 becomes smaller as the period up to the time limit becomes shorter. The size of the battery 15 is such that at least one of the width, height, and depth is smaller than the size of the housing of the battery 15 used by the first user. At this time, the control unit 31 may calculate the shape of the battery 15 so as to satisfy the capacity desired by the first user. When S202 process is completed, the process proceeds to S103. Thereafter, when the control unit 31 makes a negative determination in S109 and the control unit 31 executes S202 process again, the control unit 31 may calculate the shape of the battery 15 so that the size of the battery 15 is further reduced.

As described above, according to the present embodiment, as the time limit for collecting the batteries 15 by the control unit 31 becomes shorter, the size of the batteries 15 to be collected becomes smaller, so that the batteries 15 are more likely to be collected. That is, the battery 15 to be reused by the first user can be quickly collected. Therefore, it is possible to prevent the battery 15 collected by the first user from being wasted.

### Third Embodiment

In the third embodiment, the control unit 31 transmits the above-described notification to the second user terminal 40 corresponding to the vehicle 10 whose life expectancy is within the predetermined period. The life expectancy of the vehicle 10 may be calculated, for example, from the service life expectancy of the vehicle 10 itself or from the service life expectancy of the battery 15. Further, the service life expectancy of the vehicle 10 may be a point in time when a predetermined number of years has elapsed from the date of manufacture of the vehicle 10. The manufacturing date of the vehicle 10 may be associated with the vehicle ID, and may be input by the second user via the input unit 45 of the second user terminal 40. The information regarding the life expectancy of the vehicle 10 may be calculated by the control unit 11 of the vehicle 10 or the control unit 41 of the second user terminal 40 and transmitted to the server 30, or may be calculated by the control unit 31 of the server 30 based on the date of manufacture of the vehicle 10 associated with the vehicle ID. Further, the information on the life expectancy of the vehicle 10 may be included in the vehicle information transmitted from the vehicle 10.

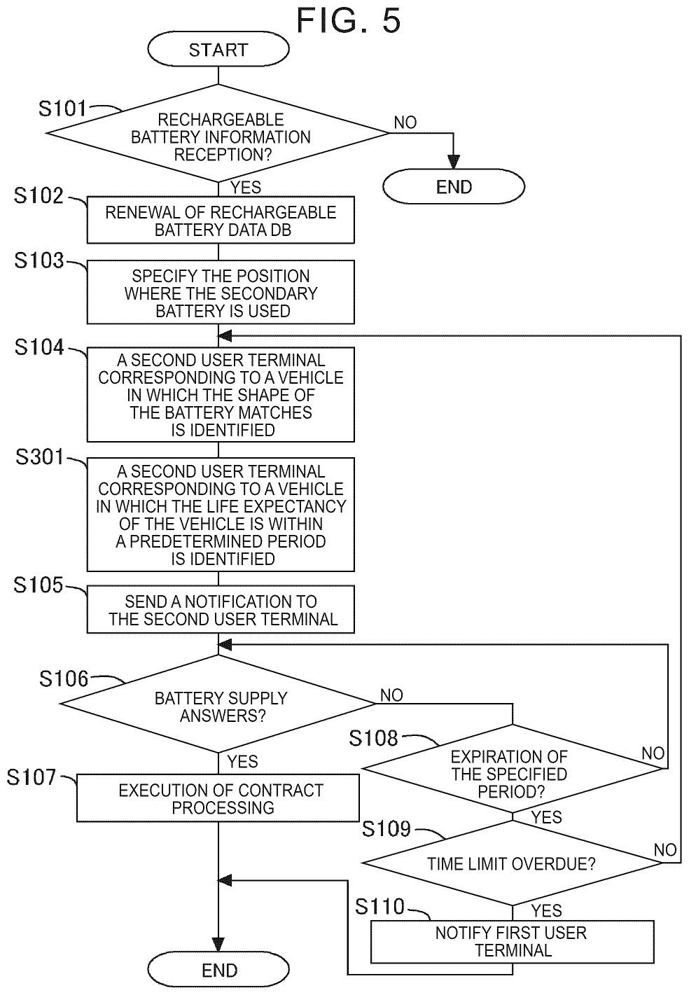

FIG. 5 is a flowchart illustrating processing when the server 30 according to the third embodiment requests the second user to provide the battery 15. The flowchart illustrated in FIG. 5 is executed in the server 30 at predetermined time intervals. It is assumed that the vehicle information DB321 stores needed information. Information regarding the life expectancy of each vehicle 10 is assumed to be acquired in advance by the control unit 31. Further, the description of the steps in which the same processing as the flowchart shown in FIG. 3 is executed is omitted.

In the flow chart shown in FIG. 5, when the process of S104 is completed, the process proceeds to S301. In S301, the control unit 31 specifies the second user terminal 40 or the vehicle 10 corresponding to the vehicle 10 whose life expectancy is within the predetermined period among the second user terminals 40 or the vehicles 10 specified by S104. Here, the predetermined period is set in advance as a period in which the possibility of replacing the vehicle 10 due to the life expectancy of the vehicle 10 is high. When S301 process is completed, the process proceeds to S105.

As described above, according to the present embodiment, since the control unit 31 transmits a notification regarding the provision of the battery 15 to the second user terminal 40 corresponding to the vehicle 10 having a short life expectancy, the battery 15 is easily gathered.

### OTHER EMBODIMENTS

The above-described embodiment is merely an example, and the present disclosure may be appropriately modified and implemented without departing from the gist thereof. The processes and means described in the present disclosure can be freely combined and implemented as long as there is no technical inconsistency. Further, the processing described as being performed by one apparatus may be performed by a plurality of apparatuses in a shared manner. Alternatively, the processes described as being performed by different devices may be performed by a single device. In a computer system, it is possible to flexibly change which hardware configuration (server configuration) realizes each function.

The present disclosure can also be realized by supplying a computer program that implements the functions described in the above embodiments to a computer, and one or more processors included in the computer read and execute the program. Such a computer program may be provided to a computer by a non-transitory computer readable storage medium connectable to a system bus of the computer, or may be provided to the computer via a network. Non-transitory computer-readable storage media include, for example, any type of disk, such as a magnetic disk (floppy disk, hard disk drive (HDD), etc.), an optical disk (CD-ROM, DVD disk, Blu-ray disk, etc.), read only memory (ROM), random access memory (RAM), EPROM, EEPROM, magnetic card, flash memory, optical card, any type of medium suitable for storing electronic instructions.

What is claimed is:

1. An information processing device, comprising a control unit that is configured to execute
acquiring first information that relates to a battery that is needed by a first user who performs secondary usage of the battery, and that includes information relating to at least a shape of the battery,
acquiring second information regarding the battery that is in use by a plurality of second users, and that includes information relating to at least the shape of the battery, and
transmitting, to a terminal of a second user corresponding to a battery from the battery that is in use by the second users and is of a shape that matches the shape of the battery that the first user needs, a notification regarding provision of the battery, in accordance with the first information and the second information.

2. The information processing device according to claim 1, wherein, when a battery that the first user needs is not obtainable within a predetermined period, the control unit transmits a notification regarding provision of the battery to a terminal of a second user corresponding to a battery of which a shape is smaller than the shape of the battery that the first user needs, from among the battery in use by the second users, in accordance with the first information and the second information.

3. The information processing device according to claim 1, wherein the control unit includes, in the notification, information regarding a price regarding provision of the battery.

4. The information processing device according to claim 1, wherein the control unit is configured to further execute
acquiring information regarding a life expectancy of a vehicle that is used by the second user and in which the battery is installed, and
transmitting the notification to the terminal of the second user corresponding to the vehicle of which the life expectancy is within a predetermined period.
